(19) United States
(12) Patent Application Publication
(10) Pub. No.: US 2005/0271896 A1
(43) Pub. Date: Dec. 8, 2005

(54) Multiple walled rolled tube and method for manufacturing same

(75) Inventors: Andreas Bernd Stahn, Rauenberg (DE); Anthony Carman, Heidelberg (DE); Randy Krause, Dryden, MI (US); Guido M. Campagna, Farmington Hills, MI (US)

Correspondence Address: YOUNG & BASILE, P.C., 3001 WEST BIG BEAVER ROAD, SUITE 624, TROY, MI, 48084, US

(73) Assignee: ITT Manufacturing Enterprises, Inc., Wilmington, DE (US)

(21) Appl. No.: 11/138,580

(22) Filed: May 26, 2005

(30) Foreign Application Priority Data
Jun. 8, 2004 (DE) 10 2004 028 020.7

(51) Int. Cl. B32B 1/08

(52) U.S. Cl. 428/685; 428/36.91

(57) ABSTRACT

A multiple walled tube is rolled from a metal strip for transporting fluids, specifically in automobile engineering, where the metal strip consists of stainless steel. A method for manufacturing such a tube, where the stainless steel strip is brazed in an H₂ atmosphere after rolling, specifically by the addition of a brazing solder.

### BACKGROUND

The invention relates to a multiple walled tube rolled from a metal strip for transporting fluids. The invention further relates to a method for manufacturing a multiple walled rolled tube.

It is known to manufacture multiple walled rolled tubes from black plate, where the steel strip has a copper or bronze coating which acts as a solder. The metal strip is galvanized after rolling and brazing and furnished with an adhesion promoter onto which a plastic coating is applied as a protective layer. A tube of this type is used, for example, as a hydraulic line on a vehicle to transport hydraulic media, for example, brake fluid. These tubes are complicated to manufacture since they still have to be protected against the effects of the environment and mechanical influences. For this reason they are galvanized and surrounded with a plastic sheath.

It would then be desirable to provide a multiple walled rolled tube which is simpler to manufacture.

### SUMMARY

The invention is a multiple walled rolled tube in which the metal strip from which the tube is made consists of stainless steel.

A steel strip of stainless steel is resistant to the effects of the environment, in particular to corrosion and perforation, and therefore does not require protection thereagainst. Furthermore, the tube is resistant, or insensitive, to mechanical influences since damage to the surface does not result directly in corrosion of the metal strip. It is therefore possible, for example, to dispense with a zinc coat and a plastic sheath so that an adhesion promoter coat also becomes superfluous.

In one aspect, the stainless steel strip has a plating, where the plating is specifically applied on both sides. The two plating coats may have the same or different dimensions and/or contain compounds. The plating coats serve to join the rolled stainless steel strip at its abutting sides, which is advantageously accomplished by brazing. To do this, the plating is a brazing solder and advantageously contains a nickel alloy. Tubes of this kind, which can also be easily chrome plated, are extremely resistant to corrosion and mechanical load.

The stainless steel strip is advantageously rolled to form a double wall. The stainless steel strip may be rolled in a helix and then it has a helical seam, or the stainless steel strip may also be rolled in the transverse direction, when it then has a longitudinal seam.

An almost stepless transition in the area of the seam is achieved by the stainless steel strip having longitudinal edges which taper to a wedge shape. This can be implemented on the inside and/or on the outside.

Additional advantages, features and details of the invention are found in the following description in which one aspect is described in detail with reference to the drawing. The features shown in the drawing and those mentioned in the description and the claims can be essential to the invention either individually or in any given combination.

### BRIEF DESCRIPTION OF THE DRAWING

In the drawing:

FIG. 1 is a side elevation view of a stainless steel strip;

FIG. 2 is a cross-section through a double-walled rolled tube; and

FIG. 3 is a perspective view of a section of a double-walled rolled tube.

### DETAILED DESCRIPTION

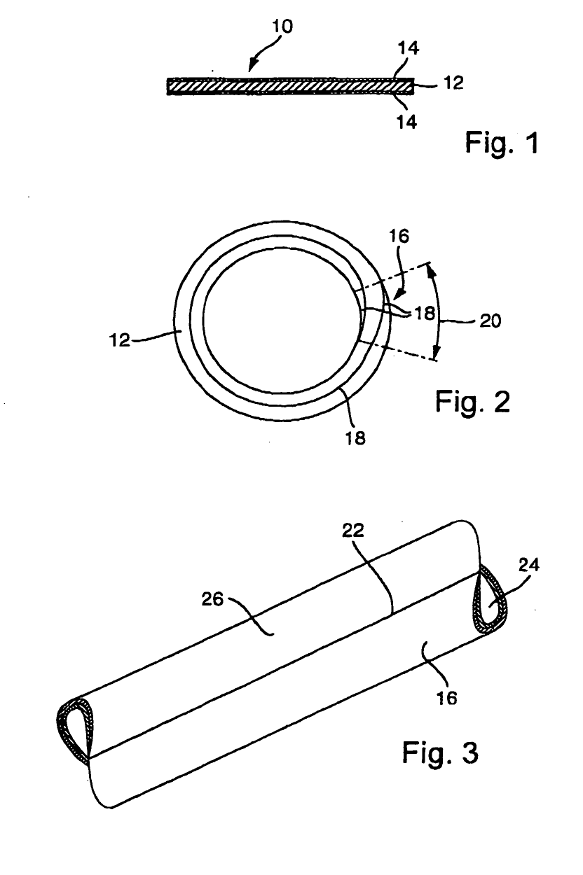

FIG. 1 represents a stainless steel strip identified by the reference numeral 10 which possesses a center layer of stainless steel 12 provided with a plating 14 on its upper side and on its lower side. This stainless steel strip 10 is rolled to form a double wall so that a tube 16 is created. The reference numeral 18 identifies a brazing seam in which the two plating coats 14 lie against each other. The sections of the plating coats 14 not attached to each other form the inner surface and the outer surface of the tube 16, where, viewed over the entire circumference, two layers of the stainless steel 12 are wound. This is achieved by the longitudinal edges 18 tapering to a wedge and overlapping in area 20 in such a way that together the edges form the thickness of a stainless steel layer.

FIG. 3 shows a section of the tube 16 where the line of the brazed seam 22 is clearly recognizable. Both the inner surface 24 and the outer surface 26 are formed by the plating 14 which contains nickel, making the tube 16 resistant to the effects of the environment.

A process is described in which the stainless steel strip is brazed in an H₂ atmosphere after rolling, in particular, by adding a brazing solder. The H₂ atmosphere prevents the stainless steel strip from tarnishing, where the brazing solder is added before or after rolling. Preferably the brazing solder, specifically in the form of nickel or a nickel alloy which is specifically phosphated or boronized, is already on the surface, specifically on both sides of the stainless steel strip.

The completed tube can be undergo further processing immediately after brazing or be wound into a coil.

The stainless steel strip can be rolled in the transverse direction and is specifically of double-wall construction. Endless tubes or tubes of specified lengths, which are extremely resistant, can be manufactured simply.

1. A multiple walled tube rolled from a metal strip for transporting fluids characterized in that the metal strip is formed of stainless steel.

2. The tube as claimed in claim 1, wherein the metal strip carries a plating.

3. The tube as claimed in claim 2; wherein the metal strip carries a plating layer on both sides.

4. The tube as claimed in claim 3, wherein the two plated layers are identical in at least one of dimensions and compositions.

5. The tube as claimed in claim 2, wherein the plating is a brazing solder.

6. The tube as claimed in claim 2, wherein the plating contains a nickel alloy.

7. The tube as claimed in claim 2, wherein the plating contains bronze.

8. The tube as claimed in claim 1, wherein the metal strip is rolled to form a double wall.

9. The tube as claimed in claim 1, wherein the metal strip is rolled in a helix and has a helical seam.

10. The tube as claimed in claim 1, wherein the metal strip in rolled in the transverse direction and has a longitudinal seam.

11. The tube as claimed in claim 1, wherein the metal strip has longitudinal edges which taper to a wedge shape.

12. A method of manufacturing a multiple walled tube rolled from a metal strip by the steps of:
forming the metal strip of stainless steel, and
brazing the strip in an H₂ atmosphere after rolling by adding a brazing solder.

13. The method as claimed in claim 12, wherein the brazing step takes place in one of a continuous oven and by induction.

14. The method as claimed in claim 12, wherein the metal strip is rolled in one of a transverse direction and in a helix.

15. The tube as claimed in claim 6 wherein the nickel alloy is one of a phosphated nickel alloy and a bronzed nickel alloy.
